(19) United States
(12) Patent Application Publication
(10) Pub. No.: US 2015/0193882 A1
(43) Pub. Date: Jul. 9, 2015

(54) BLI-Bullion Life Insurance

(71) Applicant: Maurice Jackson, Burlington, NC (US)

(72) Inventor: Maurice Jackson, Burlington, NC (US)

(21) Appl. No.: 14/147,337

(22) Filed: Jan. 3, 2014

(51) Int. Cl. G06Q 40/08

(52) U.S. Cl. CPC G06Q 40/08

(57) ABSTRACT

Method to offer life insurance that will remit the financial interest of a life insurance policy to a beneficiary redeemable in bullion after the death of the insured. The aforementioned claim can be employed through term, universal, whole life products, and is not limited to lump sum payment, BLI can function in any life insurance entity irrespective if the insurer is a mutual or stock insurance company.

### FIELD

This method relates to a payment process specifically to the beneficiaries of life insurance policies in form bullion at the death of the insured.

### BACKGROUND

To provide wealth preservation for life insurance policyholders by having policies remit bullion to the beneficiary upon the death of the insured.

### SUMMARY

This summary is provided to introduce how BLI will procure and deploy its method. This summary is not intended to identify key features or essential features of the claimed subject matter, nor is it intended to be used as an aid in determining the scope of the claimed subject matter.

### BRIEF OF FIGURES FOR DRAWINGS

Embodiments are illustrated by way of example and not limitation in the figures of the accompanying drawings, in which like references indicate similar elements and in which:

FIG. 1. BLI will receive a certified death certificate of the insured in accordance with all federal and or state requirements;

FIG. 2. BLI will provide death certificate to Reinsurance Company to release life insurance policy proceeds to BLI;

FIG. 3. BLI take life insurance proceeds from Reinsurance Company and will procure bullion. through wholesale bullion exchanges/banks, in this example: the London Bullion Metals Association, where fiat currency from the life insurance policy is converted to bullion based on spot price+premium at time of conveyance. Thereafter, the bullion is delivered from the London Bullion Metals Association to BLI;

FIG. 4. The Beneficiary receives life insurance proceeds in bullion from BLI, but has the option to surrender bullion to BLI and receive life insurance proceeds in fiat currency;

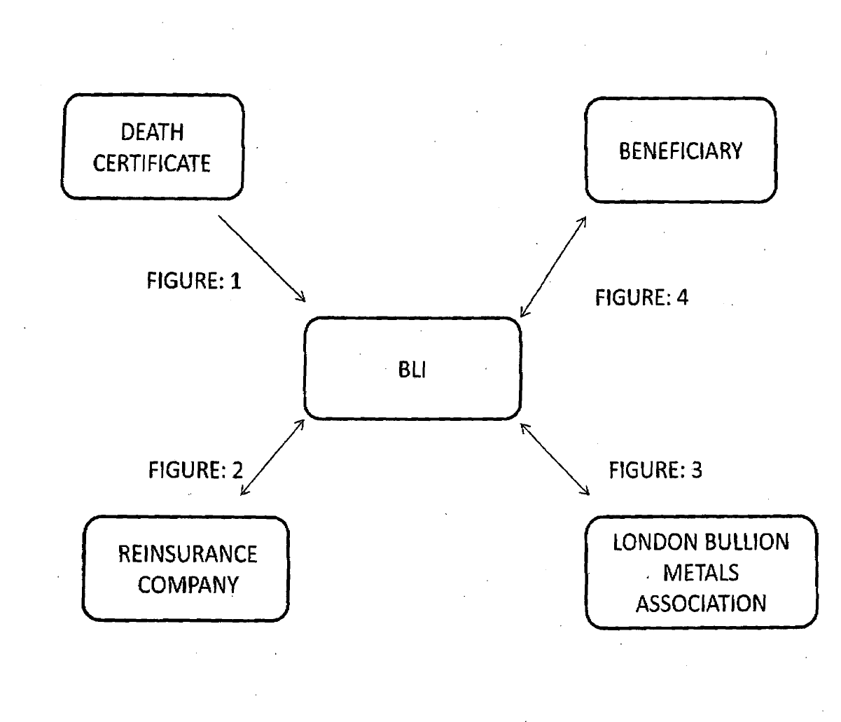

### DETAILED DESCRIPTION

BLI is designed for life insurance policy holders seeking to preserve their beneficiary's standard of living through wealth preservation through money in the form of gold or silver bullion, which is also independent of any third party counterpart risk. Whereas as a Federal Reserve Note serves as a promissory note. Therefore, a Federal Reserve Note is tied to debt juxtapose to Gold and silver bullion which are not tied to debt upon issuance as promise to pay, but are payment.

### EXAMPLE

‘BLI’ will issue a policy with a face amount of $1,000,000.00. The insured will pay a . premium commensurate with federal, state laws and underwriting practices. ‘BLI’ will outsource risk and capital requirements on its policies through reinsurance in the event of multiple death claims, which is a standard practice within the insurance industry. Upon receipt of death certificate ‘BLI’ will notify reinsurer and liquidate the corresponding policy to procure bullion in the open market. Non-government bullion will be tested for purity.

### EXAMPLE

Pace Amount $1,000,000.00 Spot Price of Gold: $2,000:

Wholesale purchase of bullion is 0.013 above spot=$2,026

Retail purchase of bullion is 0.03 above spot=$2,060

($2,026−$2060=$34 Spread)

$1,000,000.0052,026=493.58 ounces (‘BLI’ Purchases wholesale open market)

$1,000,000.0052,060=485.43 ounces (Trustee Purchases)

493.58 ounces (‘BLI’ Purchase)*$34 (Spread)=$16,781.83

(Delta: BLI vs Trustee Purchase) for ‘BLI’ (Minus Shipping and Storage costs).

(Note: In the event a beneficiary does not want to retain bullion and wants to liquidate into fiat currency ‘BLI’ will purchase the bullion from the beneficiary. ‘BLI’ will repurchase at 0.04 below spot (subject to change).

Following the example above: The policy will be paid in bullion based on spot price+0.03 per ounce (0.03 is a market premium used for example purposes only) based on the London Bullion Metals Association 1,000,000.00/Spot Price of Gold/Silver in ounces. Once ‘BLI’ receives the reinsurance, ‘BLI’ will then procure the bullion on behalf of the beneficiary who will be paid in bullion. ‘BLI’ will remit bullion to the beneficiary as prescribed per state law timeframe. The beneficiary will not be paid based on $1,000,000.00/Spot Price of Gold at the time of issuance of policy, but rather on the $1,000,000.00/Spot Price of bullion in ounces at death. Premiums will be based on traditional insurance underwriting practices: Age, Health, Lifestyle, Family History, Occupation, and storage/delivery cost for bullion.

What is claimed:

1. BLI is life insurance that is redeemable to the beneficiary in bullion upon the death of the insured, versus traditional/status quo life insurance products only remit to the beneficiary in currency units known as Federal Reserve Notes.

2. The aforementioned can be deployed through Term, Universal, and Whole Life Products independent of being fixed or indexed, furthermore, BLI can be implemented through both stock insurance or mutual insurance companies.

3. BLI will be a strategic investment in the preservation for the standard of living for the beneficiaries of the insured, BLI will alleviate the high fees assessed by Trustee's to act as a fiduciary upon execution of a will on the behalf of the insured twofold, in the first instance, the insured would have the trustee use the life insurance proceeds and procure bullion'from a retailer, this endeavor could be catastrophic for the insured and beneficiary, specifically if the trustee is not familiar with precious metals or unable to distinguish between numismatic and bullion, in the second instance, the insured would have to actually have physical ownership of bullion for the trustee to convey to the beneficiary, policy holders of BLI do not have to own, possess, or secure bullion, but rather ownership of a policy in good standing would secure their beneficiaries position for bullion ownership upon the death of the insured.
